(19) United States
(12) Patent Application Publication
(10) Pub. No.: US 2026/0152620 A1
(43) Pub. Date: Jun. 4, 2026

(54) POLYMER COMPOSITE MATERIAL CONTAINING METALLOPORPHYRIN COMPLEX, COLOR CHANGE SENSOR USING THE POLYMER COMPOSITE MATERIAL AND MANUFACTURING METHOD THEREOF

(71) Applicant: IUCF-HYU (Industry-University Cooperation Foundation Hanyang University), Seoul (KR)

(72) Inventors: Seon-Jin CHOI, Seoul (KR); Seung-Ho CHOI, Seoul (KR)

(73) Assignee: IUCF-HYU (Industry-University Cooperation Foundation Hanyang University), Seoul (KR)

(21) Appl. No.: 19/460,128

(22) Filed: Jan. 26, 2026

Related U.S. Application Data
(63) Continuation of application No. PCT/KR2024/010163, filed on Jul. 16, 2024.

(30) Foreign Application Priority Data
Jul. 26, 2023 (KR) 10-2023-0097688

(51) Int. Cl. C08K 5/00; G01N 21/78; G01N 21/80

(52) U.S. Cl. CPC C08K 5/0091; G01N 21/783; G01N 21/80

(57) ABSTRACT

Disclosed are a polymer composite material containing a metalloporphyrin complex, a color change sensor using the polymer composite material, and a manufacturing method thereof. An embodiment provides a color change sensor member, which is a polymer composite material, comprising a flexible color change sensor film based on a polymer composite material with a uniformly dispersed metalloporphyrin complex. The metalloporphyrin complex may be formed by chelating multiple metal ions with a porphyrin organic material containing multiple pyridyl groups.

### CROSS-REFERENCE TO RELATED APPLICATIONS

This U.S. non-provisional application is a continuation application of PCT International Application PCT/KR2024/010163, which has an international filing date of Jul. 16, 2024, and claims priorities under 35 U.S.C. 119 to Korean Patent Application No. 10-2023-0097688, filed on Jul. 26, 2023, in the Korean intellectual property office, the disclosures of which are herein incorporated by reference in its entirety.

### STATEMENT REGARDING GOVERNMENT SUPPORTED RESEARCH AND DEVELOPMENT

This research was supported by the Seoul RISE Center under the Regional Innovation System & Education (RISE) Seoul program (Project Title: Vitalization of Industry-Academic Cooperation Ecosystem, Project Identification Number: 2025-RISE-01-027-04) funded by the Ministry of Education, Republic of Korea, and conducted by Hanyang University (Hanyang RISE Center) from Jun. 1, 2025 to Feb. 28, 2026.

### BACKGROUND OF THE INVENTION

### Field Of Invention

Embodiments of the present invention relate to a polymer composite material including a metal-porphyrin complex, a color change sensor using the polymer composite material, and a method for manufacturing the same.

### Description of Related Art

Electrochemical sensors have the advantage of quantitatively detecting target components, but have the disadvantage of being unusable when power is depleted. Furthermore, high power consumption limits their use as portable sensors.

### BRIEF SUMMARY OF THE INVENTION

The present invention aims to provide a polymer composite material including a metal-porphyrin (metalloporphyrin) complex, a color change sensor using the polymer composite material, and a method for manufacturing the same.

The present invention provides a polymer composite material including a metal-porphyrin complex, a color change sensor utilizing this material, and a method for manufacturing the same, addressing the limitations of power-dependent electrochemical sensors. The invention offers a power-free, real-time color change sensor capable of detecting acidic gases.

The color change sensor component comprises a flexible film made from a polymer composite material in which a metal-porphyrin (metalloporphyrin) complex is uniformly dispersed. This metal-porphyrin complex is formed by the chelation of multiple metal ions with a porphyrin organic material that contains multiple pyridyl groups. The porphyrin organic material typically features a macrocyclic structure composed of four pyrrole functional groups and incorporates one or more pyridyl groups, which contain lone pair electrons, as ligands. A wide range of metal ions (e.g., Be²⁺, Mg²⁺, Ca²⁺, Sr²⁺, Ba²⁺, Ra²⁺, Fe²⁺, Cd²⁺, Cr²⁺, Co²⁺, Cu²⁺, Pb²⁺, Mn²⁺, Hg²⁺, Ni²⁺, Pt²⁺, Sn²⁺, Zn²⁺) and various polymers (e.g., PET, PEN, PC, PES, PI, COC, PDMS, and elastomers such as styrene-butadiene block copolymers, polyisoprene, polybutadiene, ethylene propylene rubber, ethylene propylene diene rubber, silicone elastomers, fluoroelastomers, polyurethane elastomers, and nitrile rubbers) can be used to form the composite. The flexible sensor film can have a thickness ranging from 10μm to 10 mm.

The sensor operates by the chemical interaction between the metal-porphyrin complex and acidic gases (such as hydrogen chloride (HCl), perchloric acid (HClO₄), chloric acid (HClO₃), chlorous acid (HClO₂), hypochlorous acid (HClO), nitric acid (HNO₃), sulfuric acid (H2SO₄), nitrogen trifluoride (NF₃), nitrous oxide (N₂O), and hydrogen fluoride (HF)), resulting in a distinct color change, typically within a pH range of 1 to 7. The manufacturing method involves: (a) preparing the metal-porphyrin complex using a chelation reaction of a metal ion with a porphyrin comprising a pyridyl functional group; (b) mixing this complex with a polymer solution to form a mixed polymer solution; (c) removing bubbles contained in the mixed polymer solution; and (d) curing the solution to produce a mechanically stable and physically flexible film. This allows for early detection of harmful gas leaks and enables application on rough or curved surfaces.

### BRIEF DESCRIPTION OF THE DRAWINGS

FIG. 1 is a diagram illustrating an example of a color change sensor member for acidic gas using a polymer composite sensing material in which a metal-porphyrin complex is uniformly dispersed, according to an embodiment of the present invention.

FIG. 2 is a diagram illustrating an example of a manufacturing process for a color change sensor member for acidic gas using a polymer composite sensing material in which a metal-porphyrin complex is uniformly dispersed, according to an embodiment of the present invention.

FIG. 3 is a flowchart illustrating an example of a manufacturing method for a color change sensor member, according to an embodiment of the present invention.

FIGS. 4A and 4B are Fourier Transform Infrared (FTIR) spectroscopy graphs of a metal-porphyrin complex manufactured according to Example 1 of the present invention.

FIG. 5 is a diagram showing the color change upon addition of hydrogen chloride (HCl) to a metal-porphyrin complex manufactured according to Example 1 of the present invention.

FIG. 6 is a diagram illustrating an image of a metal-porphyrin complex uniformly composited with an elastomer polymer solution, manufactured according to Example 2 of the present invention.

FIG. 7 is a diagram illustrating an image of a color change sensor member fabricated according to Example 2 of the present invention.

FIG. 8 is a diagram illustrating an image of an elastomer polymer manufactured according to Comparative Example 1 of the present invention.

FIG. 9 is a diagram illustrating images showing the color change before and after exposure to hydrogen chloride (HCl), an acidic gas, of an elastomer polymer composite material in which various chelated metal-porphyrin complexes are uniformly dispersed, in Experimental Example 1 of the present invention.

FIG. 10 is a graph quantitatively analyzing the color change before and after exposure to hydrogen chloride (HCl), an acidic gas, of an elastomer polymer composite material in which various chelated metal-porphyrin complexes are uniformly dispersed, in Experimental Example 1 of the present invention.

FIG. 11 is a diagram illustrating images showing the color change according to the concentration of hydrogen chloride (HCl), an acidic gas, in an elastomer polymer composite material in which a zinc-porphyrin complex is uniformly dispersed, in Experimental Example 2 of the present invention.

FIG. 12 is a graph quantitatively analyzing the color change according to the concentration of hydrogen chloride (HCl), an acidic gas, in an elastomer polymer composite material in which a zinc-porphyrin complex is uniformly dispersed, in Experimental Example 2 of the Present Invention.

FIG. 13 is a diagram illustrating images showing the color change to hydrogen chloride (HCl), an acidic gas, according to the thickness of a color change sensor film fabricated using an elastomer polymer composite material in which a zinc-porphyrin complex is uniformly dispersed, in Experimental Example 3 of the present invention.

FIG. 14 is a graph quantitatively analyzing the color change to hydrogen chloride (HCl), an acidic gas, according to the thickness of a color change sensor film fabricated using an elastomer polymer composite material in which a zinc-porphyrin complex is uniformly dispersed, in Experimental Example 3 of the present invention.

### DETAILED DESCRIPTION OF THE INVENTION

Hereinafter, embodiments will be described in detail with reference to the accompanying drawings.

Embodiments of the present invention relate to a color change sensing member, a color change sensor, and a method for manufacturing the same, which have a characteristic of changing color upon exposure to acidic gas by further compounding a metal-porphyrin complex, synthesized by chelating a metal to a porphyrin molecule having a macrocyclic structure, with a polymer. It is characterized in that the color change characteristic appears due to chemical interaction between the metal-porphyrin complex and the acidic gas. Specifically, the porphyrin molecule of the metal-porphyrin complex includes a plurality of pyridyl groups, and is characterized by exhibiting a color change characteristic by reacting with acidic gas and the lone pair of electrons included in the pyridyl group. Additionally, by chelating the metal, the electron distribution within the metal-porphyrin complex can be changed to modify its optical properties, thereby enabling the synthesis of metal-porphyrin complexes that exhibit various colors, and characterized by exhibiting different color change characteristics after reacting with acidic gas depending on the metal component. The metal-porphyrin complex can be compounded with a polymer to be used as a flexible color change sensor, and is characterized by being usable for detecting trace amounts of acidic gas generated on rough surfaces or curved edges.

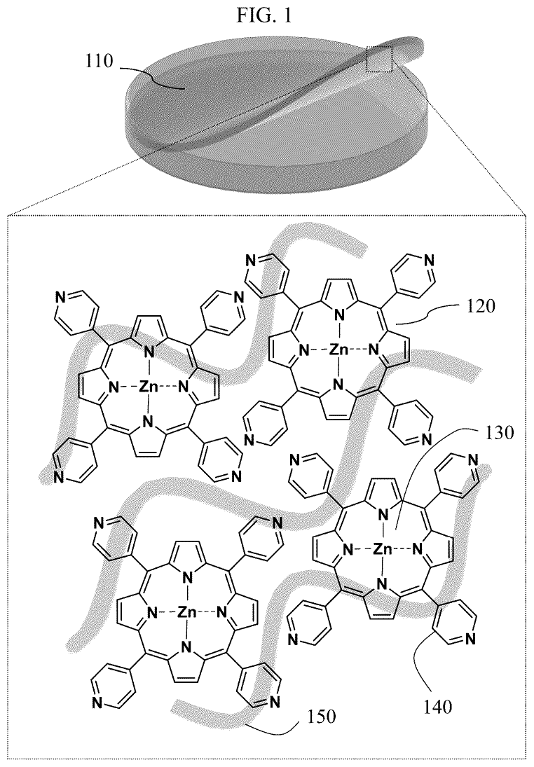

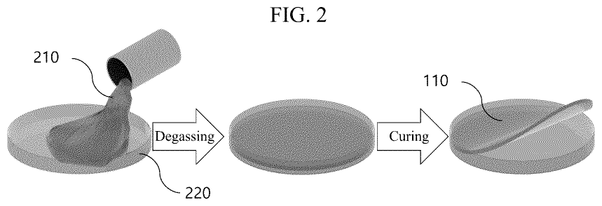

FIG. 1 is a diagram illustrating an example of a color change sensing member for acidic gas using a polymer composite material sensing material in which a metal-porphyrin complex is uniformly dispersed, according to an embodiment of the present invention, and FIG. 2 is a diagram illustrating an example of a manufacturing process of a color change sensing member for acidic gas using a polymer composite material sensing material in which a metal-porphyrin complex is uniformly dispersed, according to an embodiment of the present invention. FIG. 1 shows an example of a polymer composite material (110) including a metal-porphyrin complex (120). In this case, the metal-porphyrin complex (120) includes four pyrrole functional groups (140) as a plurality of pyridyl groups, and includes a porphyrin-based organic molecule having a macrocyclic structure. When a metal (130) is additionally chelated to the porphyrin-based organic molecule, the internal electron distribution of the organic molecule changes, and if it chemically interacts with acidic gas molecules, different color changes may appear depending on the type of metal. To this end, as shown in FIG. 2, a mixed polymer solution (210) prepared by mixing the metal-porphyrin complex (120) with a polymer (150) dissolved in a solution is poured into a Petri dish (220), and then bubbles are removed under low pressure and cured, thereby manufacturing a color change sensing member, which is a polymer composite material (110).

More specifically, the color change sensing member according to embodiments of the present invention can be utilized in a power-free real-time color change sensor that can detect harmful gas leakage early by inducing chemical interaction between a macrocyclic molecule containing lone pair electrons and an acidic gas component, thereby changing color. This color change sensing member includes a porphyrin-based organic molecule having a macrocyclic structure that includes a plurality of pyridyl groups, and when a metal is additionally chelated to the porphyrin-based organic molecule, the internal electron distribution of the organic molecule changes, and if it chemically interacts with acidic gas molecules, different color changes may appear depending on the type of metal. The metal-chelated porphyrin (metal-porphyrin) complex can be uniformly dispersed in a polymer, and can be manufactured into a color change sensor having a mechanically stable and flexible film structure through a polymer curing process, enabling it to detect trace amounts of harmful environmental gases leaking from rough surfaces or curved edges.

The color change sensing member includes a porphyrin-based organic molecule functionalized with a plurality of pyridyl groups and a metal-chelated metal-porphyrin complex, wherein the metal-porphyrin complex is uniformly dispersed in a mechanically flexible polymer and can change color through chemical interaction with acidic gas.

The metal-porphyrin complex includes a porphyrin structure and may include a plurality of pyridyl groups as ligands. Porphyrin can form metal-porphyrin complex compounds bonded with metals through chelation using a plurality of cations. In this case, the metal-porphyrin complex may include pyridyl groups having lone pair electrons. The lone pair electrons included in the pyridyl group can change the color of the metal-pyridyl complex through chemical interaction with acidic gas molecules. Therefore, the metal-pyridyl complex can be uniformly dispersed in a mechanically flexible polymer and utilized as a color change sensor sensing material that changes color upon reaction with acidic gas. The polymer has mechanically flexible properties and thus can be used as a color change sensor attached to rough surfaces or curved edges to detect trace amounts of acidic gas. A polymer composite material color change sensor with a dispersed metal-porphyrin complex can be used as a color change sensor for power-free gas detection that does not use electricity.

The color change characteristic of the polymer composite material with the dispersed metal-porphyrin complex can appear due to chemical interaction between the lone pair electrons of the pyridyl groups included in the metal-porphyrin complex and the acidic gas. The chemical reaction between the lone pair electrons and the acidic gas can occur through hydrogen bonding, protonation reaction, coordination bonding, and the like. For example, the pH of the gas changes depending on the concentration of the acidic gas, and the color can change according to the protonation reaction of the metal-porphyrin complex. Since the chemical properties of the metal-porphyrin complex vary depending on the type of chelated metal, different color changes may appear for acidic gas depending on the type of metal. Acidic gas can penetrate into the polymer composite material in which the metal-porphyrin is uniformly dispersed and chemically react with the metal-porphyrin complex, thereby exhibiting a color change.

The color change sensing member can be manufactured by uniformly dispersing the metal-porphyrin complex in a polymer. The polymer can exhibit a liquid phase before curing and after curing, it can have mechanically stable and physically flexible properties. The color change characteristics may appear differently depending on the thickness of the polymer.

The color change sensing member for acidic gas detection based on a polymer composite material with a uniformly dispersed metal-porphyrin complex, as presented in embodiments of the present invention, may include a flexible color change sensor film based on a polymer composite material with a uniformly dispersed metal-porphyrin complex. In this case, the metal-porphyrin complex can be formed as a plurality of metal ions are complexed through chelation with a porphyrin organic material containing a plurality of pyridyl groups. At this time, the flexible color change sensing member can be easily applied to rough surfaces or curved edges. Therefore, it becomes possible to provide a color change sensor that can detect trace amounts of acidic gas exposed on rough surfaces or curved edges where the color change sensing member is applied, through chemical interaction between the color change sensing member and the acidic gas.

In this case, porphyrin may include a macrocyclic structure based on heterocyclic macrocyclic organic compounds composed of four pyrrole groups. In addition, porphyrin may further include a plurality of organic ligands. Such porphyrin includes a plurality of pyridyl groups as ligands, and the pyridyl groups include lone pair electrons and can chemically interact with acidic gas components.

For example, porphyrin can be complexed with various metal ion components (Be²⁺, Mg²⁺, Ca²⁺, Sr²⁺, Ba²⁺, Ra²⁺, Fe²⁺, Cd²⁺, Cr²⁺, Co²⁺, Cu²⁺, Pb²⁺, Mn²⁺, Hg²⁺, Ni²⁺, Pt²⁺, Sn²⁺, Zn²⁺) to form a metal-porphyrin complex.

In addition, the polymer may include at least one of PET (polyethylene terephthalate), PEN (polyethylene naphthalate), PC (polycarbonates), PES (polyethersulfone), PI (polyimide), COC (cyclic olefin copolymer), and PDMS (poly-di-methyl-siloxane).

In another embodiment, the polymer may include at least one of styrene-butadiene block copolymers, polyisoprene, polybutadiene, ethylene propylene rubber, ethylene propylene diene rubber, silicone elastomers, fluoroelastomers, polyurethane elastomers, and nitrile rubbers, which are elastomers.

In addition, the polymer may further include a curing agent, and can be mechanically cured to form a mechanically stable and flexible film.

The metal-porphyrin complex can be compounded with the above-described polymer and can be uniformly dispersed inside a flexible polymer film through a curing process. In this case, the thickness of the polymer film including the metal-porphyrin complex may be in the range of 10 μm to 10 mm.

As already described, the metal-porphyrin complex of the polymer film including the metal-porphyrin complex can bind through chemical interaction with acidic gas, and a color change can appear accordingly. The acidic gas may include at least one of hydrogen chloride (HCl), perchloric acid (HClO₄), chloric acid (HClO₃), chlorous acid (HClO₂), hypochlorous acid (HClO), nitric acid (HNO₃), sulfuric acid (H₂SO₄), nitrogen trifluoride (NF₃), nitrous oxide (N₂O), and hydrogen fluoride (HF). In this case, the polymer film including the metal-porphyrin complex can exhibit chemical interaction in the acidity (pH) range of 1 to 7 of the acidic gas. In this case, the color of the polymer film including the metal-porphyrin complex can change due to the chemical interaction.

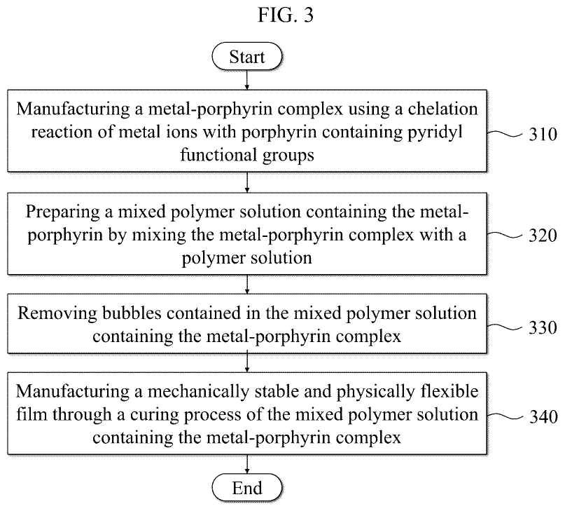

FIG. 3 is a flowchart illustrating an example of a method for manufacturing a color change sensing member according to an embodiment of the present invention. The manufacturing method according to this embodiment may include a step (310) of manufacturing a metal-porphyrin complex using a chelation reaction of metal ions with porphyrin containing pyridyl functional groups; a step (320) of preparing a mixed polymer solution containing the metal-porphyrin by mixing the metal-porphyrin complex with a polymer solution; a step (330) of removing bubbles contained in the mixed polymer solution containing the metal-porphyrin complex; and a step (340) of manufacturing a mechanically stable and physically flexible film through a curing process of the mixed polymer solution containing the metal-porphyrin complex. Thereafter, a color change sensor capable of detecting acidic gas can be manufactured using the film as a polymer composite material in which the metal-porphyrin complex is uniformly dispersed.

In step (310), a porphyrin-based organic molecule containing a plurality of pyridyl groups can be prepared by additionally functionalizing pyridyl groups to a porphyrin-based organic molecule. In this case, a metal-receptor complex can be prepared by chelating at least one metal ion selected from Be²⁺, Mg²⁺, Ca²⁺, Sr²⁺, Ba²⁺, Ra²⁺, Fe²⁺, Cd²⁺, Cr²⁺, Co²⁺, Cu²+, Pb²⁺, Mn²⁺, Hg²⁺, Ni²⁺, Pt²⁺, Sn²⁺, and Zn²⁺to the porphyrin-based organic molecule (receptor).

In step (320), the metal-porphyrin complex is added to a polymer-dispersed solution and uniformly mixed through a stirring process to prepare a mixed solution. In addition, the solvent in which the polymer is dissolved may include ethanol, methanol, propanol, butanol, isopropyl alcohol (IPA), dimethylformamide (DMF), acetone, acetonitrile, toluene, tetrahydrofuran, 1,2-dichlorobenzene, water, and a solvent selected from mixtures thereof.

In step (330), bubbles included in the mixed solution, in which the metal-porphyrin complex and the polymer are compounded, can be removed under low pressure to prepare a bubble-free mixed solution.

In step (340), a curing agent is additionally added to the polymer solution containing the metal-porphyrin complex to manufacture a mechanically stable and physically flexible film after the curing process. In this case, the polymer solution containing the metal-porphyrin complex can be cured using a UV (ultraviolet) light source to produce a mechanically stable and physically flexible film. Depending on the embodiment, the curing process may use optical curing or thermal curing. For example, the polymer solution containing the metal-porphyrin complex can be thermally cured in a temperature range of 25°C. to 200° C. to produce a mechanically stable and physically flexible film. In this case, the thickness of the film including the polymer composite material in which the metal-porphyrin complex is uniformly dispersed may be in the range of 10 μm to 10 mm.

The manufactured color change sensing member and/or the color change sensor manufactured using such a color change sensing member can provide color change characteristics as the polymer composite material, in which the metal-porphyrin complex containing a plurality of pyridyl groups is uniformly dispersed, changes color through chemical interaction with a plurality of harmful acidic gases. As described above, the color change sensing member and/or the color change sensor can detect acidic gas through color change in the acidity (pH) range of 1 to 7 of the acidic gas. In addition, the flexible film structure provides the advantage that the color change sensing member and/or the color change sensor can be easily placed on rough surfaces or curved edges, and trace amounts of harmful acidic gas leaking from such rough surfaces or curved edges can also be detected in real time.

### Example 1: Synthesis of Metal-Porphyrin Complex through Chelation of Porphyrin-based Macrocyclic Molecules Containing Pyridyl Groups with Various Metal Ions

To synthesize a metal-porphyrin complex, a metal-porphyrin complex was synthesized by chelating metal ions to a macrocyclic porphyrin (5,10,15,20-Tetrakis-(4-pyridyl)-21,23H-porphine; TPyP) containing a plurality of pyridyl groups. In this example, Zn²⁺, Mn²⁺, Co²⁺, Fe²⁺, and Cu⁺were used as metal ions to perform a chelation reaction with TPyP to synthesize metal-porphyrin complexes. Specifically, to synthesize a zinc-porphyrin complex (ZnTPyP) chelated with Zn²⁺, a solution of Zn(CH₃COO)₂·2H₂O completely dissolved in 6 mL of methanol (MeOH) was mixed with 24 mL of chloroform (CHCl₃) solution containing dissolved TPyP, and the mixed solution was heated at 65° C. for 24 hours under reflux to carry out the chemical reaction. After the reaction was completed, the solvent was removed using a rotary evaporator, the residue was washed with water, and then dried in a vacuum oven to obtain zinc-porphyrin (ZnTPyP). In the same manner, to synthesize cobalt-porphyrin (CoTPyP) and copper-porphyrin (CuTPyP) chelated with Co²⁺and Cu²⁺, respectively, Co(CH₃COO)₂·4H₂O and Cu(CH₃COO)₂·H₂O were used, and the chemical reaction was carried out through the same experimental procedure as described above to obtain cobalt-porphyrin and copper-porphyrin.

Furthermore, to synthesize an iron-porphyrin complex (FeTPyP) chelated with Fe²⁺, FeCl₂·4H2O and TPyP were dissolved in 20 mL of DMF, and the solution was heated at 160° C. for 24 hours under reflux to carry out the chemical reaction. After the reaction was completed, the solvent was removed using a rotary evaporator, the residue was washed with water, and then dried in a vacuum oven to obtain iron-porphyrin. In the same manner, to synthesize manganese-porphyrin (MnTPyP) chelated with Mn²⁺, the above experimental procedure was repeated using MnCl₂ to obtain manganese-porphyrin. Meanwhile, in synthesizing metal-porphyrin complexes, various types of metal-porphyrin complexes can be synthesized using various precursors such as Be²⁺, Mg²⁺, Ca²⁺, Sr²⁺, Ba²⁺, Ra²⁺, Fe²⁺, Cd²⁺, Cr²⁺, Co²⁺, Cu²⁺, Pb²⁺, Mn²⁺, Hg²⁺, Ni²⁺, Pt²⁺, Sn²⁺, Zn²⁺, including the metal ions used in Example 1.

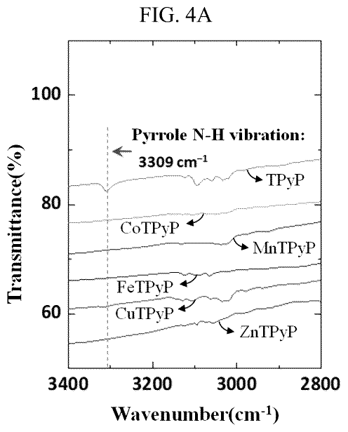

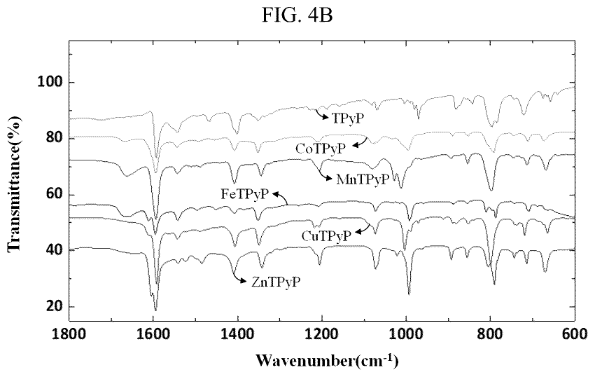

FIGS. 4A and 4B are Fourier Transform Infrared (FTIR) spectroscopy graphs of the metal-porphyrin complex prepared according to Example 1 of the present invention. The graphs in FIGS. 4A and 4B are to identify that a metal-porphyrin complex was formed by chelating metal ions to porphyrin (TPyP), and it was identified that the metal ions were chelated by the disappearance of the pyrrole N-H vibration of porphyrin (TPyP) appearing at 3309 cm⁻¹ after chelation.

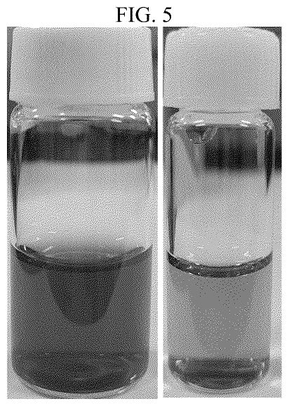

FIG. 5 is a diagram showing the color change upon addition of hydrogen chloride (HCl) to the metal-porphyrin complex prepared according to Example 1 of the present invention. In the embodiment of FIG. 5, when zinc-porphyrin (ZnTPyP) was dissolved in an aqueous solution of pH 3 and a small amount of hydrogen chloride (HCl) was added, it was observed that the color of the aqueous solution changed from purple to green. This color change can occur due to the protonation of the pyridyl groups of zinc-porphyrin (ZnTPyP).

### Example 2: Fabrication of Color Change Sensor Composite Material through Mixing of Metal-Porphyrin Complex and Elastomer Polymer

To uniformly mix the elastomer polymer and the metal-porphyrin complex, 20 mg of the metal-porphyrin complex was dispersed in 1 mL of dichloromethane (DCM). In this example, PDMS (poly-di-methyl-siloxane) was used as the elastomer polymer. The metal-porphyrin complex dispersion solution was uniformly mixed with 10 g of PDMS solution and 1 g of curing agent, and then bubbles in the solution were removed using a vacuum pump, and the DCM solvent used to disperse the metal-porphyrin complex could also be removed. Thereafter, the mixed solution was poured into a Petri dish and cured to fabricate a color change sensor having a flexible film structure. In addition, the thickness of the film can be adjusted by controlling the amount poured into the Petri dish. Since the PDMS film cured in the Petri dish is elastic, it can be easily peeled off from the Petri dish.

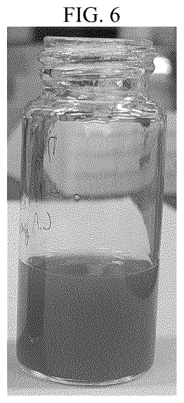

FIG. 6 is a diagram illustrating an image of a metal-porphyrin complex uniformly compounded with an elastomer polymer solution, prepared according to Example 2 of the present invention. In FIG. 6, PDMS solution with ZnTPyP uniformly mixed and completely degassed is shown. The mixed solution exhibits a color similar to that of ZnTPyP powder.

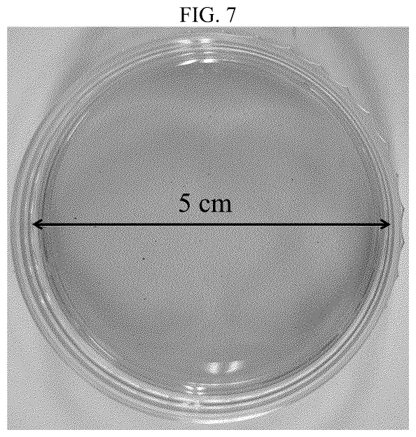

FIG. 7 is a diagram illustrating an image of a color change sensing member fabricated according to Example 2 of the present invention. FIG. 7 shows an image of PDMS containing ZnTPyP cured in a Petri dish. The Petri dish used in this example has a diameter of 5 cm, allowing for the fabrication of PDMS with the same diameter as the Petri dish.

### Comparative Example 1: Fabrication of Color Change Sensor Using Pure Elastomer Polymer Without Metal-Porphyrin Complex

To compare the color change after reaction with acidic gas of an elastomer polymer with and without a metal-porphyrin complex, a pure elastomer polymer without a metal-porphyrin complex was fabricated. In this Comparative Example 1, the process of mixing the metal-porphyrin complex solution with the PDMS solution was omitted, and a pure elastomer was fabricated by mixing the PDMS solution with a curing agent, pouring it into a Petri dish, and curing it.

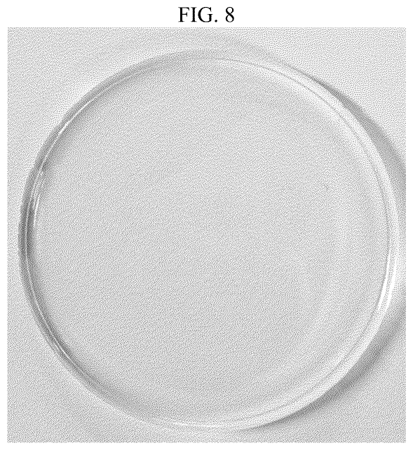

FIG. 8 is a diagram illustrating an image of the elastomer polymer prepared according to Comparative Example 1 of the present invention. PDMS without metal-porphyrin exhibits colorless and transparent optical properties.

Experimental Example 1: Evaluation of Color Change Characteristics of Color Change Sensors Fabricated According to Example 1, Example 2, and Comparative Example 1, with Respect to Acidic Gas Based on Metal Type

In this Experimental Example 1, the detection characteristics and method for acidic gas are described by evaluating the color change of the color change sensor, using both a PDMS color change sensor containing a metal-porphyrin complex fabricated according to the preceding Example 2 and a PDMS color change sensor not containing a metal-porphyrin complex fabricated according to Comparative Example 1.

The sensitivity evaluation of the PDMS color change sensor was performed by observing the color change before and after exposure to acidic gas. In this Experimental Example 1, to expose the PDMS color change sensor to acidic gas, 1 mL of hydrogen chloride solution (HCl, 37% aqueous solution) was placed in a 5 mL vial, and the PDMS color change sensor was attached to the opening of the vial to react with hydrogen chloride gas volatilizing from the hydrogen chloride solution at room temperature. In addition, to quantify the color change, photographs of the color change sensor were taken under the same conditions, and RGB (Red, Green, Blue) values were extracted using ImageJ software. Furthermore, the RGB values were converted to CIE color coordinates. CIE color coordinates are represented by L*, a*, b*, where L* represents lightness, a* represents the degree of Red and Green, and b* represents the degree of Yellow and Blue in a three-dimensional color space. The color change sensitivity ΔRGB=|(Rᵢₙᵢₜₐₗ-Rₑₓₚₒₛᵤᵣₑ)|+|(Gᵢₙᵢₜₐₗ-Gₑₓₚₒₛᵤᵣₑ)|+|(Bᵢₙᵢₜₐₗ-Bₑₓₚₒₛᵤᵣₑ)|. Here, Rᵢₙᵢₜₐₗ, Gᵢₙᵢₜₐₗ, and Bᵢₙᵢₜₐₗ represent the RGB values before exposure to acidic gas, and Rₑₓₚₒₛᵤᵣₑ, Gₑₓₚₒₛᵤᵣₑ, and Bₑₓₚₒₛᵤᵣₑ represent the RGB values after exposure to acidic gas, respectively. Furthermore, the color change sensitivity ΔE in CIE color coordinates can be calculated as ΔE=[(L*ᵢₙᵢₜᵢₐₗ-L*ₑₓₚₒₛᵤᵣₑ)²+(a*ᵢₙᵢₜᵢₐₗ-a*ₑₓₚₒₛᵤᵣₑ)^{2 +(b*}ᵢₙᵢₜᵢₐₗ-b*ₑₓₚₒₛᵤᵣₑ)²]^{1/2}, where L*ᵢₙᵢₜᵢₐₗ, a*ᵢₙᵢₜᵢₐₗ, and b*ᵢₙᵢₜᵢₐₗ represent the L*, a*, and b* values before exposure to acidic gas, and L*ₑₓₚₒₛᵤᵣₑ, a*ₑₓₚₒₛᵤᵣₑ, and b*ₑₓₚₒₛᵤᵣₑ represent the L*, a*, and b* values after exposure to acidic gas, respectively.

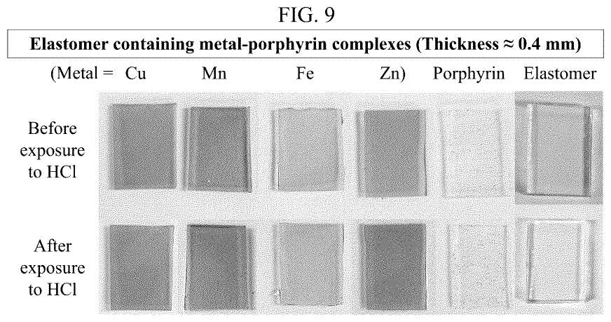

FIG. 9 is a diagram illustrating images showing the color change before and after exposure to hydrogen chloride (HCl), an acidic gas, of an elastomer polymer composite material in which various metal-chelated metal-porphyrin complexes are uniformly dispersed, in Experimental Example 1 of the present invention. It can be visually confirmed that PDMS containing the metal-porphyrin complex showed a color change, whereas pure PDMS did not show any color change.

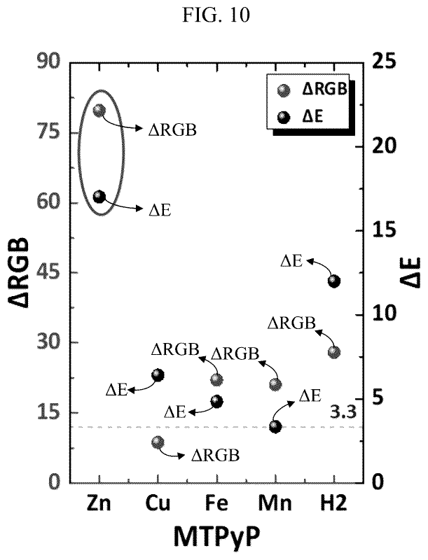

FIG. 10 is a graph quantitatively analyzing the color change before and after exposure to hydrogen chloride (HCl), an acidic gas, of an elastomer polymer composite material in which various metal-chelated metal-porphyrin complexes are uniformly dispersed, in Experimental Example 1 of the present invention. The color change shown in FIG. 9 was quantified as ΔRGB and ΔE and plotted as color change sensitivity in FIG. 10. When compared numerically, zinc-porphyrin (ZnTPyP) showed the highest ΔRGB and ΔE values.

### Experimental Example 2: Evaluation of Color Change Characteristics of Color Change Sensors Fabricated According to Example 1, Example 2, and Comparative Example 1, with Respect to Acidic Gas Concentration

In this Experimental Example 2, the color change sensitivity appearing according to the concentration of acidic gas for each of the PDMS color change sensor containing zinc-porphyrin (ZnTPyP) fabricated according to Example 2, and the PDMS color change sensor not containing a metal-porphyrin complex fabricated according to Comparative Example 1, is described.

The sensitivity characteristics of the PDMS color change sensor were evaluated by observing the color change before and after exposure to acidic gas. In this Experimental Example 2, to expose the PDMS color change sensor to acidic gas, 1 mL of hydrogen chloride solution (HCl, 37% aqueous solution) was diluted with water, injected into a 5 mL vial, and the PDMS color change sensor was attached to the opening of the vial to react with hydrogen chloride (HCl) gas volatilizing from the hydrogen chloride (HCl) solution at room temperature for 3 minutes. In addition, to quantify the color change, photographs of the color change sensor were taken under the same conditions, and RGB values were extracted using ImageJ software.

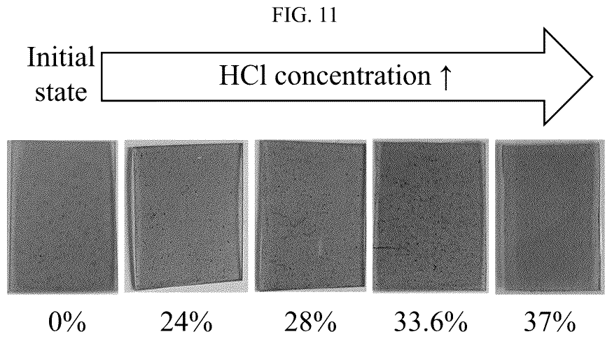

FIG. 11 is a diagram illustrating images showing the color change according to the concentration of hydrogen chloride (HCl), an acidic gas, in an elastomer polymer composite material in which a zinc-porphyrin complex is uniformly dispersed, in Experimental Example 2 of the present invention. FIG. 11 shows images of PDMS containing zinc-porphyrin (ZnTPyP) exposed to hydrogen chloride (HCl) gas using hydrogen chloride (HCl) aqueous solutions of different concentrations, and the resulting color changes. When exposed to hydrogen chloride (HCl), it can be confirmed that the color changes from brown to green. Furthermore, it can be confirmed that the higher the concentration of the hydrogen chloride (HCl) aqueous solution, the more distinct the color change observed after 3 minutes of exposure to hydrogen chloride (HCl) gas.

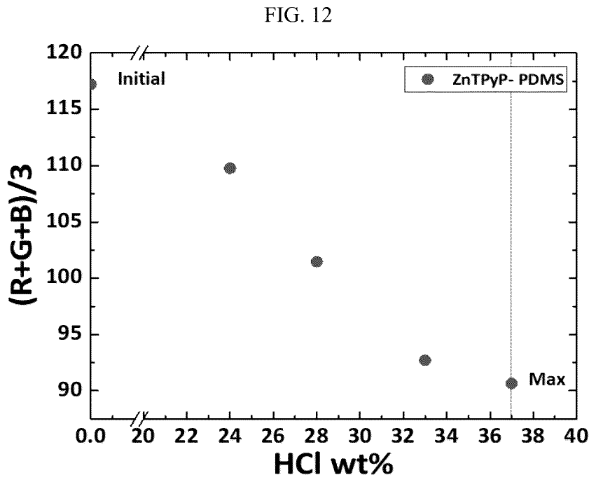

FIG. 12 is a graph quantitatively analyzing the color change according to the concentration of hydrogen chloride (HCl), an acidic gas, in an elastomer polymer composite material in which a zinc-porphyrin complex is uniformly dispersed, in Experimental Example 2 of the present invention. FIG. 12 shows a graph calculated by (R+G+B)/3 of the color change sensor exposed to different concentrations of hydrogen chloride (HCl) to confirm the trend of color change of PDMS containing zinc-porphyrin (ZnTPyP) according to the concentration of hydrogen chloride (HCl) aqueous solution. In the state before exposure to hydrogen chloride (HCl), (R+G+B)/3 was 117.22, and upon exposure to hydrogen chloride (HCl) gas, (R+G+B)/3 gradually decreased, reaching 90.64 when exposed to hydrogen chloride (HCl) gas generated from a 37% aqueous solution of hydrogen chloride (HCl).

### Experimental Example 3: Evaluation of Color Change Characteristics of Color Change Sensors Fabricated According to Example 1, Example 2, and Comparative Example 1, with Respect to Acidic Gas Based on Sensor Thickness

In this Experimental Example 3, the color change sensitivity appearing upon reaction with acidic gas according to the thickness of the PDMS color change sensor containing zinc-porphyrin (ZnTPyP) fabricated according to Example 2 and the PDMS color change sensor fabricated according to Comparative Example 1 is described.

The sensitivity characteristics of the PDMS color change sensor were evaluated by observing the color change before and after exposure to acidic gas. In this Experimental Example 3, PDMS color change sensors of different thicknesses were prepared and exposed to acidic gas in the same manner as in Experimental Example 1. In addition, to quantify the color change, photographs of the color change sensor were taken under the same conditions, RGB values were extracted using ImageJ software, and then converted to CIE color coordinates L*, a*, b*.

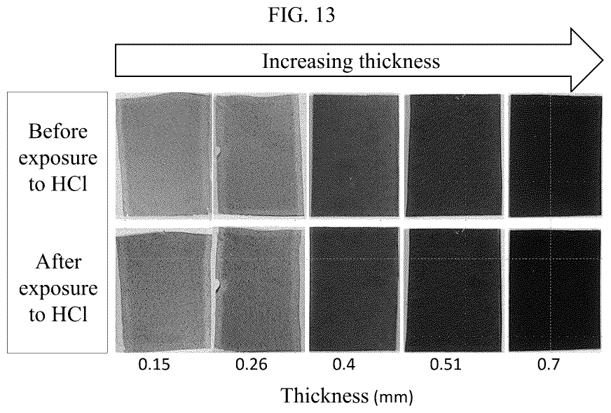

FIG. 13 is a diagram illustrating images showing the color change to hydrogen chloride (HCl), an acidic gas, according to the thickness of a color change sensor film fabricated using an elastomer polymer composite material in which a zinc-porphyrin complex is uniformly dispersed, in Experimental Example 3 of the present invention. FIG. 13 shows images before and after exposure to hydrogen chloride (HCl) gas according to the thickness of the color change sensor. It can be visually observed that the color of the color change sensor changes from brown to green after exposure to hydrogen chloride (HCl).

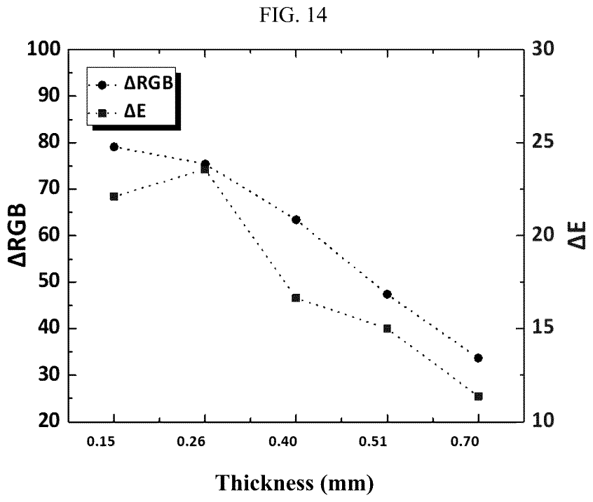

FIG. 14 is a graph quantitatively analyzing the color change to hydrogen chloride (HCl), an acidic gas, according to the thickness of a color change sensor film fabricated using an elastomer polymer composite material in which a zinc-porphyrin complex is uniformly dispersed, in Experimental Example 3 of the present invention. FIG. 14 shows the color change sensitivity ΔRGB and ΔE of the color change sensor to hydrogen chloride (HCl) gas as a graph according to the thickness of the sensor. It can be confirmed that ΔRGB decreases as the thickness increases. In addition, ΔE shows a maximum value at a thickness of 0.26 cm.

As described above, according to embodiments of the present invention, a metal-porphyrin complex can be formed through a chelation process between porphyrin, which has a macrocyclic molecular structure including pyridyl groups, and a metal. The metal-porphyrin complex can be uniformly mixed and compounded with a polymer, thereby enabling the fabrication of a color change sensing member with a mechanically stable and flexible film structure through the curing process of the polymer containing the metal-porphyrin complex. The color change sensing member can detect acidic gas through a color change resulting from chemical interaction between the lone pair electrons of the pyridyl groups and the acidic gas upon exposure to the acidic gas.

Although the embodiments have been described with reference to limited examples and drawings, various modifications and variations can be made from the above description by those skilled in the art. For example, even if the described techniques are performed in a different order than described, and/or components such as the described systems, structures, devices, and circuits are combined or associated in a different form than described, or replaced or substituted by other components or equivalents, appropriate results can be achieved. Therefore, other implementations, other embodiments, and equivalents of the claims also fall within the scope of the claims described below.

What is claimed is:

1. A color change sensor member, comprising:
a flexible color change sensor film formed of a polymer composite material in which a metalloporphyrin complex is uniformly dispersed,
wherein the metalloporphyrin complex is formed by chelation of a plurality of metal ions with a porphyrin organic material comprising a plurality of pyridyl groups.

2. The color change sensor member of claim 1, wherein the porphyrin organic material is composed of a ring structure of four pyrrole functional groups and comprises at least one pyridyl group comprising a lone pair of electrons as a ligand.

3. The color change sensor member of claim 1, wherein the metal ion is one of Be²⁺, Mg²⁺, Ca²⁺, Sr²⁺, Ba²⁺, Ra²⁺, Fe²⁺, Cd²⁺, Cr²⁺, Co²⁺, Cu²⁺, Pb²⁺, Mn²⁺, Hg²⁺, Ni²⁺, Pt²⁺, Sn²⁺, and Zn²⁺.

4. The color change sensor member of claim 1, wherein the polymer forming the polymer composite material comprises at least one of polyethylene terephthalate (PET), polyethylene naphthalate (PEN), polycarbonates (PC), polyethersulfone (PES), polyimide (PI), cyclic olefin copolymer (COC), and poly-di-methyl-siloxane (PDMS).

5. The color change sensor member of claim 1, wherein the polymer forming the polymer composite material comprises at least one elastomer selected from styrene-butadiene block copolymers, polyisoprene, polybutadiene, ethylene propylene rubber, ethylene propylene diene rubber, silicone elastomers, fluoroelastomers, polyurethane elastomers, and nitrile rubbers.

6. The color change sensor member of claim 1, wherein the thickness of the flexible color change sensor film is in a range of 10 μm to 10 mm.

7. The color change sensor member of claim 1, wherein the metalloporphyrin complex is chemically bonded through chemical interaction with an acidic gas comprising at least one of hydrogen chloride (HCl), perchloric acid (HClO₄), chloric acid (HClO₃), chlorous acid (HClO₂), hypochlorous acid (HClO), nitric acid (HNO₃), sulfuric acid (H₂SO₄), nitrogen trifluoride (NF₃), nitrous oxide (N₂O), and hydrogen fluoride (HF).

8. The color change sensor member of claim 1, wherein the flexible color change sensor film exhibits a color change in a pH range of 1 to 7.

9. A method for manufacturing a color change sensor member, the method comprising:
(a) manufacturing a metalloporphyrin complex using a chelation reaction of a metal ion with a porphyrin comprising a pyridyl functional group;
(b) preparing a mixed polymer solution comprising the metalloporphyrin complex by mixing the metalloporphyrin complex with a polymer solution;
(c) removing bubbles included in the mixed polymer solution comprising the metalloporphyrin complex; and
(d) manufacturing the color change sensor member configured in the form of a mechanically stable and physically flexible color change sensor film by a polymer composite material in which the metalloporphyrin complex is uniformly dispersed, through a curing process of the mixed polymer solution comprising the metalloporphyrin complex.

10. The method for manufacturing a color change sensor member of claim 9, wherein in the step (b), the solvent of the polymer solution comprises a solvent selected from ethanol, methanol, propanol, butanol, isopropyl alcohol (IPA), dimethylformamide (DMF), acetone, acetonitrile, toluene, tetrahydrofuran, 1,2-dichlorobenzene, water, and mixtures thereof.

11. The method for manufacturing a color change sensor member of claim 9, wherein in the step (c), bubbles included in the mixed polymer solution, in which the metalloporphyrin complex and the polymer are compounded, are removed under reduced pressure.

12. The method for manufacturing a color change sensor member of claim 9, wherein before the step (d), a curing agent is additionally added to the mixed polymer solution to form a mechanically stable and physically flexible film after the curing process.

13. The method for manufacturing a color change sensor member of claim 9, wherein in the step (d), the curing process forms a mechanically stable and physically flexible film using optical curing or thermal curing.

14. The method for manufacturing a color change sensor member of claim 13, wherein in the step (d), the thermal curing process forms a mechanically stable and physically flexible film through thermal curing in a temperature range of 25° C. to 200° C.

15. The method for manufacturing a color change sensor member of claim 9, further comprising:
(e) manufacturing a color change sensor that detects acidic gas using the film.

16. The method for manufacturing a color change sensor member of claim 9, wherein the film is used as a member of a color change sensor that detects acidic gas subtly leaking from rough surfaces or curved edges in real-time by a color change.
